(19) United States
(12) Patent Application Publication
(10) Pub. No.: US 2024/0409475 A1
(43) Pub. Date: Dec. 12, 2024

(54) INTERMEDIATE-RELEASE FERTILIZERS AND METHODS FOR MAKING SAME

(71) Applicant: OSTARA NUTRIENT RECOVERY TECHNOLOGES INC., Calgary (CA)

(72) Inventors: Ahren BRITTON, Calgary (AB); Mikaela VERIGIN, Calgary (AB); Roland LEATHERWOOD, Calgary (CA); Ram Prasad Melahalli SATHYANARAYANA, Calgary (CA)

(73) Assignee: OSTARA NUTRIENT RECOVERY TECHNOLOGES INC., Calgary, AB (CA)

(21) Appl. No.: 18/703,210

(22) PCT Filed: Oct. 18, 2022
(86) PCT No.: PCT/CA2022/051536

§ 371 Date: Apr. 19, 2024

Related U.S. Application Data
(60) Provisional application No. 63/262,968, filed on Oct. 23, 2021.

(51) Int. Cl. C05B 7/00; C05B 1/00; C05B 9/00; C05B 19/00; C05G 3/40; C05G 5/12

(52) U.S. Cl. CPC C05B 7/00; C05B 1/00; C05B 9/00; C05B 19/00; C05G 3/44; C05G 5/12

(57) ABSTRACT

A fertilizer comprises an intermediate-release source of phosphorus. The intermediate-source of phosphorus may be schertelite. In one embodiment, the intermediate-source of phosphorus may consist substantially all of the phosphorous content in the fertilizer. In other embodiments, the fertilizer further comprises one or both of a slow-release and fast-release source of phosphorus. The fertilizer may be in the form of a homogenous prill. A number of methods may be used to make such fertilizers.

### CROSS-REFERENCE TO RELATED APPLICATIONS

This application claims priority from U.S. application No. 63/262,968 filed 23 Oct. 2021 and entitled INTERMEDIATE-RELEASE FERTILIZERS AND METHODS FOR MAKING SAME which is hereby incorporated herein by reference for all purposes. For purposes of the United States of America, this application claims the benefit under 35 U.S.C. § 119 of U.S. application No. 63/262,968 filed 23 Oct. 2021 and entitled INTERMEDIATE-RELEASE FERTILIZERS AND METHODS FOR MAKING SAME which is hereby incorporated herein by reference for all purposes.

### TECHNICAL FIELD

The invention relates to fertilizers for plants. Some embodiments of the invention provide release of nutrients on an intermediate time scale. Some embodiments of the invention provide methods for making such fertilizers.

### BACKGROUND

Nitrogen (N), phosphorus (P), and potassium (K) are the main nutrients needed for plant growth and development. For example, phosphorus helps transfer energy from sunlight to plants, stimulates early root and plant growth, and hastens maturity. Fertilizers provide such nutrients in available forms for plants to take up as required to promote plant growth and development. Fertilizers may additionally contain other active materials including secondary nutrients, such as magnesium (Mg), sulfur (S) and calcium (Ca), micronutrients such as boron (B), chlorine (CI), copper (Cu), iron (Fe), manganese (Mn), molybdenum (Mo), zinc (Zn), and nickel (Ni), pesticides, herbicides, etc.

A problem with some fertilizers is that their composition contains one or more materials that can cause root and/or seedling damage to plants upon application. This can reduce the germination rate, or injure developing roots and thus reduce crop yield.

A desirable fertilizer releases nutrients efficiently to provide optimum plant growth over all or a portion of a growing season. Some fertilizers comprise water-soluble components. Highly water-soluble components rapidly permeate the soil and may be lost via leaching, run-off or chemical binding with soil minerals. Some fertilizers comprise substantially water-insoluble components. Substantially water insoluble components may be released over longer time scales, which provide nutrients to plants over a prolonged period. A fertilizer that delivers nutrients to plants at an optimal release rate can provide plants with a better opportunity to uptake the nutrients. Such a fertilizer may reduce leaching, run-off or chemical binding of fertilizer components.

There is a need for improved fertilizer compositions that can supply plants with nutrients (especially phosphorous) efficiently. There is also a need for improved fertilizer compositions which will result in reduced damage to roots and/or seedlings caused by fertilizer application.

The foregoing examples of the related art and limitations related thereto are intended to be illustrative and not exclusive. Other limitations of the related art will become apparent to those of skill in the art upon a reading of the specification and a study of the drawings.

### SUMMARY

The present invention has a number of aspects. One aspect of the invention provides a fertilizer that, in use, tends to release phosphorous in a form available to plants more rapidly than slow-release fertilizers in which phosphorus is provided in the form of compounds that are sparingly soluble in water, such as struvite, and more slowly than fast-release fertilizers in which phosphorus is provided in the form of compounds that are highly soluble in water, such as monoammonium phosphate (MAP) or diammonium phosphate (DAP). Such fertilizers may be called “intermediate-release” fertilizers. Intermediate-release fertilizers may comprise one or more “intermediate-release” sources of phosphorus. An intermediate-release source of phosphorus has a solubility in water that is greater than that of sparingly soluble compounds such as struvite and less than that of highly water-soluble compounds such as MAP or DAP. Intermediate-release fertilizers as described herein can release plant-available phosphorus and other nutrients to crops at a rate that is greater than that of fertilizers that include only slow-release sources of phosphorus and less than that of fertilizers that include only fast-release sources of phosphorus.

The inventors have determined that a good intermediate-release source of phosphorus is schertelite. Schertelite is a compound having the composition: Mg(NH₄)₂H₂(PO₄)₂·4H₂O.

In some embodiments:
the fertilizer is made up of particles which include an intermediate-release source of phosphorus (e.g., schertelite);
the fertilizer is made up of particles which include both an intermediate-release source of phosphorus (e.g., schertelite) and a slow-release source of phosphorus (e.g., struvite);
the fertilizer is made up of particles which include both an intermediate-release source of phosphorus (e.g., schertelite) and a fast-release source of phosphorus (e.g., a water-soluble phosphorus containing material such as MAP and/or DAP); and
the fertilizer is made up of particles which include an intermediate-release source of phosphorus (e.g., schertelite), a slow-release source of phosphorus (e.g., struvite), and a fast-release source of phosphorus (e.g., a water-soluble phosphorus containing material such as MAP and/or DAP).

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a graph illustrating the release profiles of example fertilizers according to an embodiment.

FIG. 2 is a magnified view of a fertilizer particle according to a first embodiment.

FIG. 3 is a magnified view of a fertilizer particle according to a second embodiment.

FIG. 4 is a magnified view of a fertilizer particle according to a third embodiment.

FIG. 5 is a magnified view of a fertilizer particle according to a fourth embodiment.

FIG. 6 is a process diagram illustrating a first example method for making fertilizer particles.

FIG. 7 is a process diagram illustrating a second example method for making fertilizer particles.

FIG. 8 is a graph showing germination rate for canola as a function of phosphate application rate for various sources of phosphorus listed in Table 2.

### DESCRIPTION

Throughout the following description specific details are set forth in order to provide a more thorough understanding to persons skilled in the art. However, well-known elements may not have been shown or described in detail to avoid unnecessarily obscuring the disclosure. Accordingly, the description and drawings are to be regarded in an illustrative, rather than a restrictive, sense.

Fertilizers that Include Intermediate Sources of Phosphorus, in Particular Schertelite

An aspect of the invention relates to a fertilizer that comprises an intermediate-release source of phosphorus. The intermediate-release source of phosphorus releases phosphorus for take up by plants at a rate between the phosphorus release rates of fast-release sources of phosphorus (e.g. MAP or DAP) and slow-release sources of phosphorus (e.g. struvite). In some embodiments the intermediate-release source of phosphorus comprises or consists of schertelite.

Schertelite has the chemical formula (NH₄)₂MgH₂(PO₄)₂·4(H₂O). Schertelite is composed of approximately 8.6% nitrogen, 43.8% P₂O₅, and 7.5% magnesium by weight. Schertelite may be formed by reacting a source of phosphorus with a source of magnesium. The source of phosphorus may for example be monoammonium phosphate (MAP), diammonium phosphate (DAP), struvite (or magnesium-ammonium-phosphate with the chemical formula MgNH₄PO₄·6H₂O) and/or the raw materials that form these compounds such as phosphoric acid and ammonia. The source of magnesium may for example be periclase (also known as magnesium oxide with the chemical formula MgO) and/or brucite (also known as magnesium hydroxide Mg(OH)₂).

In some embodiments, the content of schertelite in the fertilizer is in the range of from about 2% to about 80% by weight or about 5% to about 80% by weight. In some embodiments, the content of schertelite in the fertilizer is at least 10% by weight or greater than about 10% by weight. In some embodiments, the content of schertelite in the fertilizer is approximately 45% by weight.

Fast-release sources of phosphorus have high water solubility which allows them to rapidly permeate the soil upon application. Fast-release sources of phosphorus may for example have solubility in excess of 300 g/L (e.g. in the range of about 300 g/L to about 600 g/L or more) at 20° C. in water.

Slow-release sources of phosphorus have low water solubility which allows them to be released into the soil over longer time periods. Slow-release sources of phosphorus may for example have solubility in the range of about 170 mg/L or less to about 180 mg/L at 25° C. in water.

The intermediate-release source of phosphorus can have a solubility in water at 20° C. that is between the solubility ranges for fast and slow-release sources of phosphorus. For example, The intermediate-release source of phosphorus may have a solubility in water at 20° C. that is in the range of more than 180 mg/L to less than 300 g/L, in the range of about 200 mg/L to about 200 g/L or in the range of about 400 mg/L to about 40 g/L.

In some embodiments the intermediate-release source of phosphorus has a percentage water-soluble phosphorus content relative to its total phosphorus content in the range of 20-80%, or in the range of 40-75%, or in the range of 50-70% or approximately 58%.

In some embodiments, the intermediate-release source of phosphorus has a percentage water-soluble phosphorus content relative to its total phosphorus content that is at least two thirds of that of MAP. In some embodiments, the intermediate-release source of phosphorus has a percentage water-soluble phosphorus content relative to its total phosphorus content that is in the range of about 25% to about 95% of that of MAP.

In some embodiments, substantially all of the phosphorus nutrients available in the fertilizer are provided by the intermediate-release source of phosphorus. In some embodiments, the fertilizer comprises the intermediate-release source of phosphorus as the major source of phosphorus in the fertilizer (i.e. the intermediate-release source of phosphorus provides more than half of the total phosphorus provided by the fertilizer). In some embodiments the intermediate-release source of phosphorus makes up over 70% or over 80% or over 90% of the total available phosphorus in the fertilizer.

Fertilizers that Combine Intermediate-Release Sources of Phosphorus with Other Sources of Phosphorus

In other embodiments, the fertilizer comprises other sources of phosphorus in addition to the intermediate-release source of phosphorus. The fertilizer may for example comprise one or both of a slow-release phosphorus and a fast-release source of phosphorus in combination with the intermediate-release source of phosphorus.

Fertilizers that Combine Intermediate-Release and Fast-Release Sources of Phosphorus

In embodiments in which the fertilizer includes a fast-release source of phosphorus, the fast-release source of phosphorus may, for example, be a water-soluble phosphorus-containing material that comprises or is derived from a suitable phosphate. A suitable phosphate includes for example phosphoric acid, single super phosphate (SSP), double super phosphate (DSP), triple super phosphate (TSP), monoammonium phosphate (MAP), diammonium phosphate (DAP), dicalcium phosphate, or a combination of two or more of the foregoing. In example embodiments, the fast-release source of phosphorus is MAP. In other example embodiments, the fast-release source of phosphorus is a combination of MAP and DAP. The content of the fast-release source of phosphorus in the fertilizer may, for example, be in the range of from just above 0% to about 75% by weight.

In some embodiments which combine one or more intermediate-release sources of phosphorus and one or more fast-release sources of phosphorus the water soluble phosphorus pentoxide (P₂O₅) content in the intermediate-release source of phosphorus is less than the water soluble P₂O₅ content of the fast-release source of phosphorus. In some embodiments, the water soluble P₂O₅ content of the intermediate-release source of phosphorus is about 5% to about 70% less than the water soluble P₂O₅ content of the fast-release source of phosphorus. In some embodiments, the water soluble P₂O₅ of the intermediate-release source of phosphorus is about 40% to about 70% less than the water soluble P₂O₅ content of the fast-release source of phosphorus. In some embodiments, the water soluble P₂O₅ content of the intermediate-release source of phosphorus is 10% or more lower than the water soluble P₂O₅ content of the fast-release source of phosphorus.

Fertilizers which Combine Intermediate-Release and Slow-Release Sources of Phosphorus

In some embodiments in which the fertilizer includes a slow-release source of phosphorus, the slow-release source of phosphorus may, for example, be or include struvite or dittmarite which has the chemical formula (NH₄)Mg(PO₄)·H₂O. In some embodiments a fertilizer additionally or in the alternative includes one or more other slow-release sources of phosphorus such as phosphate rock or hydroxyl apatite.

In some embodiments the fertilizer comprises both one or more intermediate-release sources of phosphorus and one or more slow-release sources of phosphorus such as struvite or dittmarite or phosphate rock or hydroxyl apatite. For example, the fertilizer may comprise schertelite together with struvite or dittmarite in a desired ratio. For example the fertilizer may comprise or consist essentially of schertelite together with struvite or schertelite together with dittmarite in a molar ratio in the range of 10:90 to 90:10.

In some embodiments which combine one or more intermediate-release sources of phosphorus and one or more slow-release sources of phosphorus, the water soluble P₂O₅ content of the intermediate-release source of phosphorus is at least 2 times greater than the water soluble P₂O₅ content of the slow-release source of phosphorus. In some embodiments, the water soluble P₂O₅ content of the intermediate-release source of phosphorus is about 2 to 5 times greater than the water soluble P₂O₅ content of the slow-release source of phosphorus.

### Other Fertilizer Characteristics

In some embodiments, fertilizers as described herein have a water soluble phosphorus pentoxide (P₂O₅) content that is greater than about 25% of the total P₂O₅ in the fertilizer. In some embodiments, the water-soluble P₂O₅ content in the fertilizer is in the range of from about 15% to about 85% or 25% to 75% or 40 to 70% of the total P₂O₅ in the fertilizer.

In some embodiments, fertilizers as described herein have free moisture content or ground moisture content less than about 10% by weight. In some embodiments, the free moisture content, or ground moisture content of the fertilizer is less than about 4% by weight.

In some embodiments, fertilizers as described herein comprise additional materials to provide other inorganic nutrients or micronutrients (e.g., zinc, boron and sulfur) and/or additional sources of nitrogen, potassium and magnesium useful for plant growth or health. For example, polyhalite, a naturally occurring evaporate mineral with the formula K₂Ca₂Mg(SO₄)₄·2H₂O may be intermixed with the other materials in the fertilizer to provide sources of sulfur (S) and calcium (Ca), as well as additional sources of potassium (K) and magnesium (Mg) to the crop. Other active materials such as pesticides, selective herbicides, and the like, may optionally be included in the fertilizer.

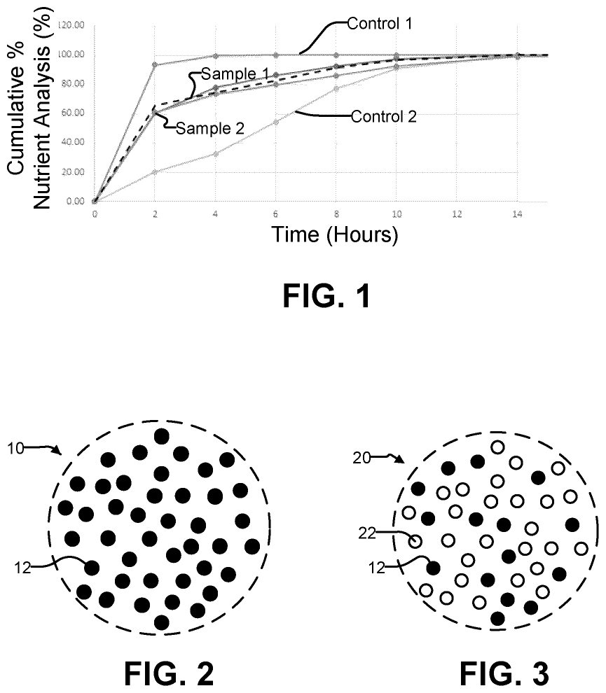

FIG. 1 is a graph showing release profiles (Cumulative release of nutrients as a function of time) as determined by accelerated release tests for example fertilizers comprising an intermediate-release source of phosphorus (Sample 1—composition #3 in Table 1 and Sample 2—composition #1 in Table 1). The release profiles for a fertilizer comprising a fast-release source of phosphorus (Control 1—MAP), and a fertilizer comprising a slow-release source of phosphorus (Control 2—pure struvite) are provided as controls.

In an accelerated release test, a column containing a fertilizer or other material being tested is flushed several times with a mildly acidic solution to determine how many flushing cycles it takes to fully dissolve the fertilizer. The accelerated release test simulates the release of nutrients from fertilizers in cropping soils and provides a basis for comparing expected release rates of different fertilizers in cropping soils.

The data in FIG. 1 is the result of testing by the ANRT method. Each of the materials (Sample 1, Sample 2, Control 1, Control 2) was tested in duplicate. For all materials, three grams of poly-fil was placed into the bottom of each column. A three gram sample of each material was weighed and charged to each column. An additional three grams of poly-fil was placed into the upper section of each column to prevent solid particles from being evacuated during testing.

The columns were heated indirectly (jacketed column) to 50° C. using a hot water circulation system. A 0.2% citric acid solution was continuously circulated through each test column using a peristaltic metering pump at a flow rate of 4.017 mL/min. to release the product nutrients. After each time interval test cycle, the citric acid solution was evacuated and stored for analysis. Fresh citric acid solution was charged to each test column as testing resumed. This continual changing of citric acid solution was performed at the following time intervals:
1. First Extraction=after 2 hours at 50° C.
2. Second Extraction=after 2 hours at 50° C.
3. Third Extraction=after 2 hours at 50° C.
4. Fourth Extraction=after 2 hours at 50° C.
5. Fifth Extraction=after 2 hours at 50° C.
6. Sixth Extraction=after 4 hours at 50° C.
7. Seventh Extraction=after 8 hours at 50° C.
8. Eighth Extraction=after 4 hours at 50° C.
9. Ninth Extraction=after 4 hours at 50° C.

Once the 30 hour accelerated nutrient release test was complete, each citric acid filtrate sample was analyzed for total phosphorus and magnesium using approved analytical methods. A Perkin-Elmer ICP-OES was used for Magnesium, and a scalar segmented flow analyzer was used for measuring P₂O₅.

The release profiles of FIG. 1 show the percentage of the total amount of phosphorus pentoxide (P₂O₅) released from each fertilizer over time. The release profiles in FIG. 1 show that the immediate-release source of phosphorous should release phosphorus into the soil at a rate between the phosphorus release rates of the fast-release source of phosphorus and the slow-release source of phosphorus.

Fertilizers as described herein can provide highly efficient phosphate release to the crops throughout the growing season. As compared to a conventional water soluble phosphorus fertilizers, such a fertilizer produces crops with improved root development and/or increased germination rates and/or crop yield. Less leaching and/or run-off of water soluble phosphorus from the soil have also been observed from the application of such a fertilizer as compared to the application of a conventional water soluble phosphorus fertilizers. This fertilizer is particularly advantageous for use in growing sensitive crops which are prone to seedling injury, or in areas where nearby waterbodies are sensitive to nutrient runoff or eutrophication.

The fertilizer may provide at least one of the primary inorganic nutrients, nitrogen (N), phosphorus (P), potassium (K) and magnesium (Mg) required by a crop. In some embodiments, the fertilizer comprises a nitrogen content in the range of about 3% to about 20% by weight. In some embodiments, the fertilizer comprises a phosphorus content, expressed in the form of P₂O₅, in the range of from about 20% to about 50% by weight. In some embodiments, the fertilizer comprises a potassium content in the range of from about 0% to about 20% by weight. In some embodiments, the magnesium content in the fertilizer is in the range of from about 1% to about 20% by weight. In an example embodiment, the fertilizer has a N-P-K rating of about 8-43-0+3.5 Mg, where N is the nitrogen content by weight percentage, P is the phosphorous content by weight percentage as P₂O₅, and K is the potassium content by weight percentage as K₂O. In another example embodiment, the fertilizer has a N-P-K rating of about 5-28-0+10 Mg.

Table 1 below lists example fertilizer compositions comprising schertelite, one or both of struvite and a fast-release source of phosphorus and one or more other intermediate products. The contents of each of the materials where present are expressed in percent by weight of the fertilizer.

TABLE 1
Example fertilizer compositions comprising schertelite (wt %)

| | % | % | % | % | % | % | % | % | % | % | % | % |
|---|---|---|---|---|---|---|---|---|---|---|---|---|
| Sample | Struvite | Schertelite | MAP | DAP | Polyhalite | Periclase | Brucite | Dittmarite | Hannayite | Mascagnite | Newberyite | Bassanite |
| #1 | 4.3 | 60.9 | 19.0 | | | 1.8 | | 7.6 | 4.0 | | 2.3 | |
| #2 | 2.9 | 52.4 | 35.9 | | | | | 4.6 | 4.3 | | | |
| #3 | 21.6 | 54.7 | 0.2 | | | 5.0 | | 18.5 | | | | |
| #4 | | 57.4 | 35.6 | | | | | | | 1.3 | | 1.1 |
| #5 | | 23.1 | 58.6 | | | | | | 5.3 | 0.0 | | 5.4 |
| #6 | 2.8 | 28.9 | 53.3 | | | 0.2 | 2.1 | 2.3 | 1.7 | 2.4 | | 3.8 |
| #7 | 2.3 | 22.3 | 55.5 | 0.5 | | 0.1 | 3.0 | 3.2 | 6.2 | 1.9 | | 2.9 |
| #8 | 1.4 | 7.7 | 59.9 | 0.4 | | | 2.6 | 13.3 | 6.3 | 3.3 | | 2.5 |
| #9 | 69.5 | 2.1 | | | | | 15.0 | 12.2 | | | | 15.0 |
| #10 | 36.5 | 3.1 | | | | | 11.7 | 45.8 | | | | 11.7 |
| #11 | 24.3 | 59.9 | | 0.8 | | 0.7 | 6.9 | 1.3 | 1.0 | 1.4 | | 2.1 |
| #12 | 72.1 | 1.9 | | | | 2.4 | | 9.8 | 6.1 | 2.1 | | 3.1 |
| #13 | 7.2 | 69.4 | 4.9 | | | 8.3 | | 10.3 | | | | |
| #14 | 2.8 | 15.2 | 2.4 | 59.5 | | 1.0 | | 15.8 | | 2.9 | | |
| #15 | 2.2 | 6.0 | 0.3 | 70.1 | | 2.7 | 0.5 | 14.4 | | 2.7 | | |
| #16 | | 16.5 | 22.0 | | 31.3 | | | 6.3 | 10.15 | | | 2.2 |

Table 1A lists some additional illustrative fertilizer compositions. The wt. % values in Table 1A do not take into account non-nutritive materials such as non-nutritive binders that may be present in some embodiments.

TABLE 1A
Example fertilizer compositions comprising schertelite (wt %)

| | | | Total | | | Total | | |
|---|---|---|---|---|---|---|---|---|
| | Schertelite | Struvite | Slow | DAP | MAP | Fast | Polyhalite | Other |
| Name | (wt %) | (wt %) | (wt %) | (wt %) | (wt %) | (wt %) | (wt %) | (wt %) |
| A | About 100 | | | | | | | <5 |
| B | 25-50 | 0-30 | 10-30 | 0-65 | 0-65 | 0-65 | | <10 |
| C | 35-60 | 0-65 | 30-65 | 0-35 | 0-35 | 0-35 | | <5 |
| D | 40-50 | 0-40 | 0-40 | 0-50 | 0-50 | 20-50 | | <20 |
| E | 10-90 | | | | | | 10-90 | <20 |
| F | 25-50 | | 0-30 | | | 30-65 | | <10 |
| G | 10-90 | 10-90 | 10-90 | 0-90 | 0-90 | 10-90 | | <20 |
| H | 20-60 | 40-70 | 40-80 | 0-40 | 0-40 | 0-40 | | <10 |

### Fertilizer Forms

Fertilizers as described herein may be in the form of granules or homogenous prills. FIGS. 2-5 are schematic diagrams illustrating example fertilizer particles 10, 20, 24, 28, respectively. FIG. 2 illustrates fertilizer particle 10 which comprises particles of schertelite 12. Particles of schertelite 12 may be homogeneously distributed throughout fertilizer particle 10. In some embodiments, the schertelite 12 provides substantially all of the phosphorus nutrients available in fertilizer particle 10.

FIG. 3 illustrates fertilizer particle 20 which comprises particles of struvite 22 intermixed with particles of schertelite 12.

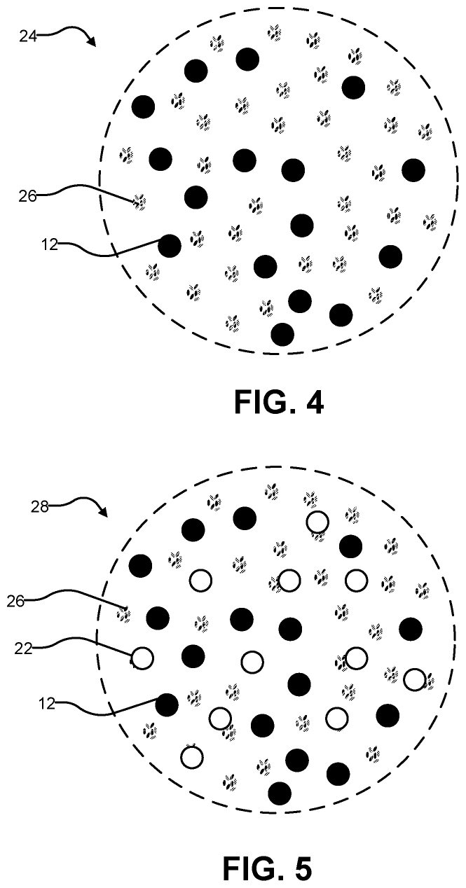

FIG. 4 illustrates fertilizer particle 24 which comprises particles of a source of fast-release phosphorus 26 intermixed with particles of schertelite 12.

FIG. 5 illustrates fertilizer particle 28 which comprises particles of a fast-release source of phosphorus 26 and a slow-release source of phosphorus (e.g. struvite) 22. intermixed with particles of schertelite 12.

In example embodiments, fertilizer particles 10, 20, 24, 28 are characterized by a diameter in the range of from about 0.2 mm to about 20 mm. In some embodiments, fertilizer particles 10, 20, 24, 28 have a diameter in the range of about 2 to about 4 mm. Particle sizes may be described by a size guide number (SGN). SGN is given by the diameter of the median granule size in millimeters multiplied by 100. For example, a SGN of 311 corresponds to a median particle size of 3.11 mm. In some embodiments, fertilizer particles 10, 20, 24, 28 have a size at or between about size guide number (SGN) 250 and about 350 SGN.

Particle sizes may also be described by a uniformity index. The uniformity index is a comparison of large particles to small particles. The index is expressed as a whole number between 1 and 100 with higher numbers indicating better uniformity and tighter size range. In one embodiment, the uniformity index of the fertilizer particles 10, 20, 24, 28 is greater than about 45. In another embodiment, the uniformity index of the fertilizer particles 10, 20, 24, 28 is greater than about 50.

Fertilizer particles 10, 20, 24, 28 with a SGN of approximately 300 may have a hardness or crush strength of at least about 3 lbf. In example embodiments, fertilizer particles 10, 20, 24, 28 with SGN of approximately 300 may have a hardness or crush strength greater than about 5 lbf.

In some embodiments, fertilizer particles 10, 20, 24, 28 are spherical or substantially spherical in shape. In some embodiments, fertilizer particles 10, 20, 24, 28 are elliptical or substantially elliptical in shape. Fertilizer particles 10, 20, 24, 28 may have an angular shape (i.e., a shape having one or more angles). Fertilizer particles 10, 20, 24, 28 may have other shapes.

Fertilizer particles 10, 20, 24, 28 may have a level of crystallinity in the range of from about 87% to about 94%.

In some embodiments, particles of struvite 22 and/or fast-release source of phosphorus 26 and particles of schertelite 12 are in the form of distinguishable particles within fertilizer particles 20, 24, 28. Fertilizer particles 20, 24, 28 may for example be in the form of layers of struvite 22 and/or fast-release source of phosphorus 26 and schertelite 12. Fertilizer particles 20, 24, 28 may have structures that include alternating layers of minerals.

In other embodiments, particles of struvite 22 and/or fast-release source of phosphorus 26 and schertelite 12 are in the form of indistinguishable particles within fertilizer 20, 24, 28 (i.e., in the form of very small particles that are indistinguishable without a microscope). In such embodiments, struvite 22 and/or fast-release source of phosphorus 26 and schertelite 12 may be combined to form a substantially or essentially homogenous mixture of mineral particles within fertilizer particles 20, 24, 28.

Schertelite 12 and/or struvite and/or fast-release phosphorus 26 may have self-binding properties (i.e., the particles can bind together to form fertilizer particles 10, 20, 24, 28) such that additional materials are not used to bind the particles together. In other embodiments, fertilizer particles 10, 20, 24, 28 optionally comprise a binder for use in binding together particles of schertelite 12 and struvite 22 and/or fast-release phosphorus 26 (if present). Suitable binders may include for example calcium lignosulphonates, starch, molasses, and/or MAP.

Fertilizer particles 10, 20, 24, 28 may optionally be coated with a coating. In some embodiments, the coating comprises an anti-dust material. The anti-dust material assists with reducing or entrapping the dust that is created during production, transport, and application of fertilizer particles 10, 20, 24, 28. In some embodiments, the coating comprises an anti-caking agent. The anti-caking agent assists with reducing the tendency of fertilizer particles 10, 20, 24, 28 to agglomerate and form large bulky lumps. The anti-dust material and/or the anti-caking agent may comprise, for example, waxes, petroleum products, and polymers.

Another example form of a fertilizer as described herein is a blend of first particles made primarily of one or more intermediate-release sources of phosphorous and second particles which comprise one or more fast-release sources of phosphorus and/or one or more slow-release sources of phosphorus. The first particles may, for example consist essentially of schertelite or a mixture of schertelite with one or more of struvite and dittmarite.

A granular fertilizer may, for example comprise:
schertelite (5% to 85% by weight),
struvite (0% to 80% by weight) and
a source of fast-release phosphorus (0% to 65% by weight)
   as required for a desired application.

In some embodiments, the fertilizer particles comprise about 100% by weight of schertelite. In some embodiments, the fertilizer particles comprise schertelite in the range of from about 2% to about 100% by weight, struvite in the range of from about 0% to about 70% by weight, and the source of fast-release phosphorus in the range of from about 0.2% to about 70% by weight.

### Material Sources

A slow-release source of phosphorus may be produced by reacting two or more raw materials. The slow-release source of phosphorus may alternatively or additionally be obtained as a by-product of wastewater processes. As an example, struvite may be produced by reacting a source of phosphorus with a source of magnesium. Struvite may also be harvested from wastewater that contains sufficient concentrations of nutrients. Struvite from one or both of these sources of struvite may be used in fertilizers as described herein. In such embodiments, the content of the slow-release source of phosphorus in the fertilizer is in the range of 0% to about 70% by weight.

Conveniently, schertelite may be made as an intermediate product in a reaction for producing struvite. Furthermore the reaction may be controlled to produce a desired mixture of schertelite and struvite.

In an example embodiment, schertelite is formed by reacting MAP and MgO in the presence of water. A theoretical reaction mechanism of the formation of schertelite from MAP (i.e., the source of phosphorus) and MgO (i.e., the source of magnesium) is:

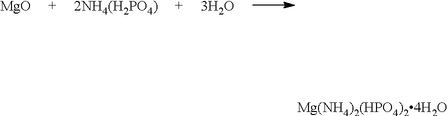

Schertelite is not stable in the presence of water. In the presence of excess magnesium and water, schertelite converts to struvite. A theoretical reaction mechanism of the conversion of schertelite to struvite is shown below:

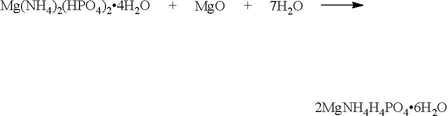

Schertelite is an intermediate product formed in the production of struvite, as illustrated in the example theoretical reaction mechanisms above. In some embodiments, a fertilizer as described herein that comprises struvite in combination with schertelite. Struvite may in those embodiments be the slow-release source of phosphorus. The desired concentration of schertelite in the fertilizer may be achieved by favoring or disfavoring the conversion to struvite from schertelite. Reaction factors that may affect the resulting concentrations of struvite and schertelite include for example:
addition rates of magnesium and phosphorus;
free moisture content;
conditions of the reaction, such as temperature, pH, etc.;
quantity and/or type and/or form of other input raw materials.
Reactivity and particle size distribution of the input materials
Form of the raw materials (i.e. dry particles vs dissolved or slurries)

The desired concentration of schertelite in the fertilizer may be obtained by controlling the molar ratio of magnesium to phosphorus (Mg:P ratio). Decreasing the Mg:P ratio may increase the formation of schertelite and thereby decrease the formation of struvite. Increasing the Mg:P ratio may decrease the formation of schertelite and thereby increase the formation of struvite. In some embodiments, the Mg:P ratio of the fertilizer is less than about 1.5. In some embodiments, the Mg:P ratio of the fertilizer is between about 0.1 and about 1.5. In some embodiments, the Mg:P ratio of the fertilizer is between about 0.2 to about 1.2.

In addition to schertelite, the fertilizer may comprise one or more other intermediate products. The one or more other intermediate products may be formed in the production of the intermediate- and/or slow-release sources of phosphorus. The one or more other intermediate products may provide additional sources of nutrients that may be beneficial to a crop. Such intermediate products may include for example one or more of: dittmarite with the formula (NH₄)MgPO₄·H₂O, hannayite with the formula (NH₄)₂Mg₃H₄(PO₄)₄·8H₂O, newberyite with the formula Mg(HPO₄)·3H₂O.

In some embodiments the fertilizer may comprise some impurities that may be present in raw materials such as minor amounts of mascagnite and/or bassanite which are impurities commonly found in MAP and DAP.

In some embodiments, the fertilizer does not comprise significant amounts (e.g. more than about 4% by weight) of any of the other intermediate products above. In some embodiments the total content of the one or more other intermediate products in the fertilizer is, for example, less than about 20% by weight. In some embodiments larger amounts of such intermediate products are retained in the fertilizer. The content of dittmarite in the fertilizer may be in the range of from about 0% to about 60% by weight. The content of dittmarite vs struvite can be controlled by operating at higher temperatures in the granulation system. For example temperatures above approximately 56 degrees Celsius favor increased formation of dittmarite over struvite. The content of hannayite, newberyite, in the fertilizer (if any one or more of these compounds are present) may each, for example, be in the range of from 0% to about 10% by weight.

### Manufacturing Methods

Granules or homogeneous prills like fertilizer particles 10, 20, 24, 28 may be made in various ways. The following are some non-limiting example processes for making fertilizers as described herein.

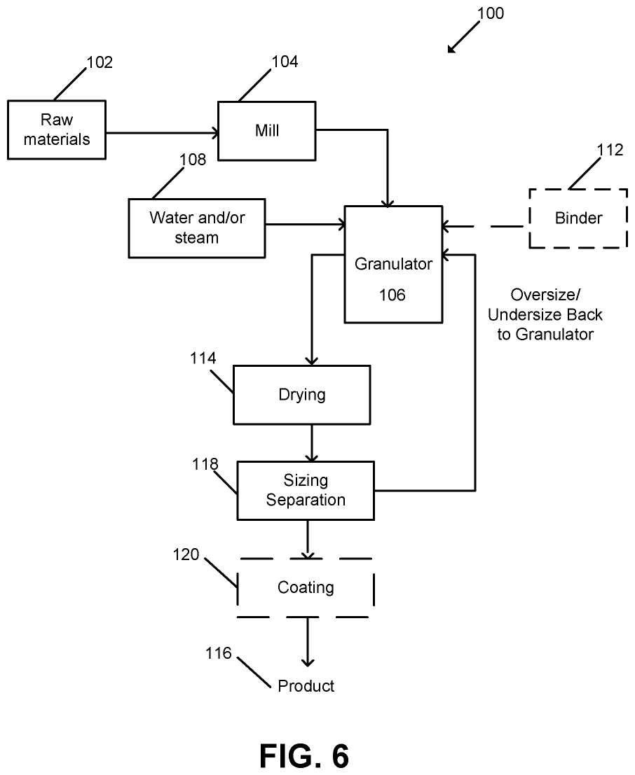

FIG. 6 illustrates a process 100 according to one example embodiment. Process 100 involves chemical granulation. In process 100, granules or homogenous prills may be formed by accretion. In process 100, raw materials 102 are powdered, for example, by crushing or grinding in a suitable mill 104 (unless the raw materials 102 are already in the form of suitably small particles). In some embodiments, raw materials 102 may have a size distribution of less than about 200 mesh. In some embodiments, raw materials 102 may have a size distribution of less than about 325 mesh.

Raw materials 102 may include fines of schertelite 12 and optionally fines of struvite 22 and/or a fast-release source of phosphorus 26. Alternatively, raw materials 102 may include a combination of inorganic compounds that will react to form schertelite 12 and/or struvite 22 and/or a fast-release source of phosphorus material 26.

For example, in some embodiments, raw materials 102 include a source of phosphorus and a source of magnesium to form schertelite 12 and/or struvite 22. The source of phosphorus may be one or more of monoammonium phosphate (MAP), diammonium phosphate (DAP), struvite (or magnesium-ammonium-phosphate with the chemical formula MgNH₄PO₄·6H₂O) and/or the raw materials that form these compounds such as phosphoric acid and ammonia. The source of magnesium may be one or more of periclase (also known as magnesium oxide with the chemical formula MgO) and/or brucite (also known as magnesium hydroxide Mg(OH)₂), or could be obtained in the form of impurities in phosphoric acid or MAP/DAP, particularly if manufactured from lower grade ores with elevated magnesium content. The input struvite may for example be obtained as a by-product from wastewater processes.

In embodiments in which the fertilizer includes a source of fast-release phosphorus material 26, raw materials 102 may include, for example, monoammonium phosphate (NH₄H₂PO₄), diammonium phosphate ((NH₄)₂HPO₄), triple-super phosphate (also known as monocalcium phosphate with the chemical formula (CaH₄P₂O₈)), anhydrous ammonia, phosphoric acid, or a combination of two or more of these inorganic compounds to form the source of fast-release phosphorus material 26. Raw materials 102 may be in any suitable form, e.g., solid, gas, liquid or slurry (i.e., a semiliquid mixture).

Raw materials 102 are introduced into a granulator 106. Suitable granulators that can be used include a rotary drum, pan granulator, mechanical mixing device and roller press/compactors. In some embodiments, raw materials 102 are premixed prior to introduction into granulator 106. A mechanical mixing device such as a pug mill or pipe cross reactor (not shown) may be used for the premixing. In some embodiments, raw materials 102 are mixed directly in granulator 106. The mixing facilitates uniform distribution of the raw materials, promotes the chemical reactions in forming schertelite and/or struvite and/or the source of fast-release phosphorus material by bringing the raw materials in close contact with each other, and assists with the encapsulation or agglomeration of the particles into the granules. In some embodiments, one or more of raw materials 102 are introduced into granulator 106 as a slurry (i.e., mixture of one or more raw materials and water) or a binder material.

In some embodiments, water and/or steam 108 is introduced into granulator 106 in an amount sufficient to cause the raw materials to form the desired amount of schertelite and/or struvite and/or the source of fast-release phosphorus material and agglomerate into granules having the desired size and properties. Water and/or steam 108 may be introduced into granulator 106 by injection using sprays or spargers for example. In some embodiments, a sufficient amount of water and/or steam 108 is added to raw materials 102 to form granules (granules output by granulator 106).

The particular makeup of the fertilizer granule product depends on the reaction conditions of the granulation process. Non-exhaustive reaction conditions include 1) temperature, 2) pH, 3) moisture content, 4) reaction time. In example embodiments, the operating temperatures of the granulation process are maintained at approximately 10° C. to 70° C. The operating temperature of the granulation process may be obtained by varying the temperatures of the raw materials and/or by controlling the temperature of granulator 106.

Process 100 may comprise a curing period. During the curing period some proportion of intermediate products may continue to react to form struvite. The curing typically results in an increased hardness of the fertilizer granules. Exposing the fertilizer granules to levated moisture/humidity during the curing period tends to accelerate curing. The curing period may, for example be approximately 24 to 96 hours.

Optionally a binder 112 is added to granulator 106. Compounds such as calcium lignosulphonate, starch, guar gum, molasses binders, or the like may be used as binders. The binder(s) may enhance granule strength and cohesiveness, accelerate the formation of the granule product and/or to provide granules with improved physical properties (e.g. density, hardness, resistance to breaking/crumbling under handling and storage).

Granules output by granulator 106 are dried at 114 to enhance granule strength, stop the chemical reactions, and reduce the excess moisture content in the granules. In some embodiments, the excess moisture content in the dried granule product 116 is less than about 10%. In some embodiments, the excess moisture content in the dried granule product 116 is less than about 4%.

Dried granules are then screened at 118 to yield product size material. Granules of sizes outside of a desired range (oversize and/or undersize) may be returned to granulator 106. In some embodiments, oversized and/or undersized granules may be crushed or pulverized prior to returning to granulator 106.

Optionally, the product 116 is coated with a coating agent at 120 to reduce dust and/or cake formation and enhance product strength. Examples of suitable coating agents include waxes, petroleum products, and polymers.

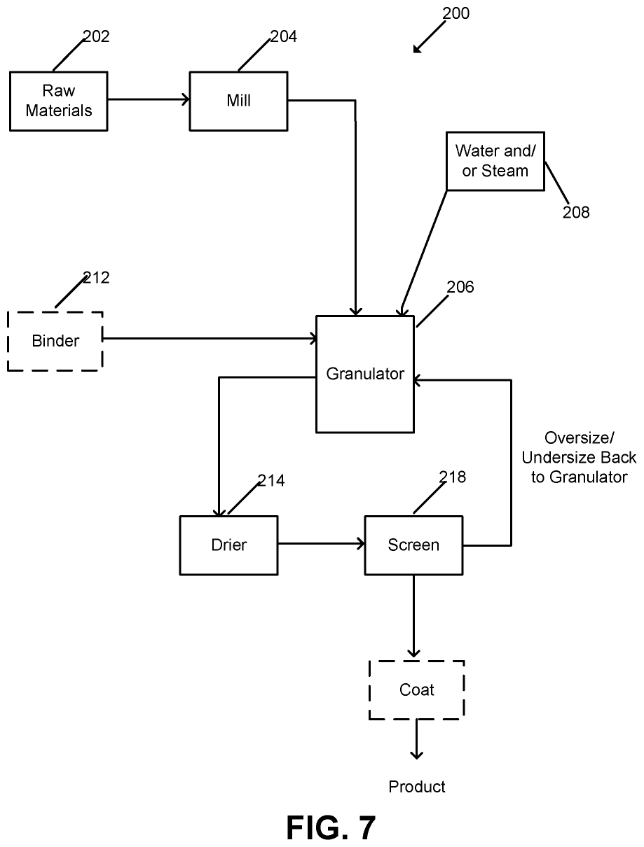

FIG. 7 illustrates a process 200 according to another example embodiment which produces fertilizer granules by steam/water granulation. In process 200, raw materials 202 are powdered, for example by crushing or grinding in a suitable mill 204 (unless the raw materials 202 are already in the form of suitably small particles). A binder 212 (e.g., MAP, calcium lignosulphonates, starch or molasses etc.) may be introduced into granulator 106 to enhance agglomeration.

Optionally, raw materials which may optionally include one or more liquids, are premixed, for example in a pug mill or similar device (not shown) prior to being fed into granulator 206. Raw materials 202 may also be added into granulator 206 by a recycle path (the recycle path may carry, for example, recycle dry product and/or crushed oversize material and/or undersized material).

Steam and/or water 208 and/or binder 212 is introduced into granulator 206 in an amount sufficient to cause the dry raw materials to agglomerate into granules having the desired size and properties.

Granules are dried at a drier 214 and screened at a screen 218 or other size selector to separate product size granules from granules that are oversize or undersize. Oversized and undersized granules may be crushed and recycled to granulator 206. If required, the product may be coated to reduce dust and/or cake formation and enhance product strength.

### Field Test Results

### Canola

In a field trial growing canola, fertilizer as described herein comprising homogeneous prills of schertelite co-granulated with struvite, dittmarite and MAP was applied. A comparison plot was fertilized with a fertilizer comprising a blend of struvite particles with MAP granules. It was found that the fertilizer comprising the schertelite generated a 12.3% higher yield than the struvite-MAP blend. The total amount of phosphate and the amount of phosphate provided in the form of struvite and MAP were the same in both cases.

This field trial showed that canola germination is less inhibited by MAP when the MAP is combined with struvite and schertelite in a single prill. Seedlings germinated on media containing increasing concentrations of phosphate application from homogenous prills of 25%, or 38% struvite combined with 75% or 62% MAP, respectively, exhibited statistically similar germination to seedlings germinated on three different varieties of 100% struvite. Germination of seedlings on media with only DAP or MAP was inhibited at even the lowest application rate.

Table 2 describes phosphate sources used in these field trials.

TABLE 2
Phosphate Sources

| Phosphate | | |
|---|---|---|
| Source | Notes | Mineral Content |
| DAP | Di-Ammonium Phosphate | DAP |
| MAP | Mono-Ammonium Phosphate | MAP |
| 25/75 Syn | Co-granulated (homogenous prill) 25% Struvite + | Struvite + |
| | 75% MAP, resulting in a granule containg schertelite | Schertelite + |
| | and dittmarite as well as the raw materials. | Dittmarite + MAP |
| 38/62 Syn | Co-granulated (homogenous prill) 38% Struvite + | Struvite + |
| | 62% MAP, resulting in a granule containg schertelite | Schertelite + |
| | and dittmarite as well as the raw materials. | Dittmarite + MAP |
| CGO | | Struvite |
| ADMIX | | Struvite + |
| | | Schertelite + |
| | | Dittmarite |
| CGNXT | ground down and compacted 300 SGN sized product | Struvite + dittmarite |
| | | (<2%) |

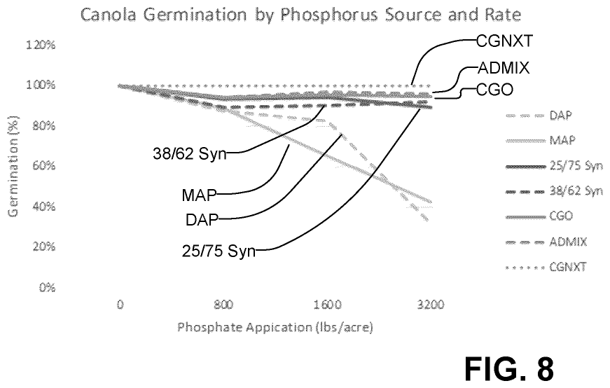

FIG. 8 is a graph showing germination rate for canola as a function of phosphate applicant rate for various sources of phosphorus listed in Table 2.

### Sugar Beets

In a field trial growing sugar beets, fertilizers as described herein comprising homogenous prills of schertelite co-granulated with struvite, dittmarite and MAP and homogenous prills of schertelite co-granulated with struvite, dittmarite and DAP were applied. The fertilizer comprising the homogeneous prills of schertelite and MAP were manufactured using 25% struvite and 75% MAP expressed as the total percentage of P₂O₅. The fertilizer comprising the homogeneous prills of schertelite and DAP were manufactured using 27% struvite and 73% DAP expressed as the total percentage of P₂O₅. A comparison plot was fertilized with a fertilizer comprising a blend of struvite particles with MAP granules. The struvite-MAP blend comprises 25% struvite and 75% MAP, expressed as the total percentage of P₂O₅. The struvite in the struvite-MAP blend was obtained as a by-product of wastewater processes. It was found that the fertilizer comprising the homogenous prills of schertelite and MAP generated a 4.8% higher yield than the fertilizer comprising the homogenous prills of schertelite and DAP, and a 5.2% higher yield than the struvite-MAP blend.

### Wheat

In a field trial growing wheat, fertilizer as described herein comprising homogeneous prills of schertelite co-granulated with struvite, dittmarite and MAP was applied. A comparison plot was fertilized with a fertilizer comprising a blend of struvite particles with MAP granules. It was found that the fertilizer comprising the schertelite generated a 2.6% higher yield than the struvite-MAP blend. The total amount of phosphate and the amount of phosphate provided in the form of struvite and MAP were the same in both cases.

These trials found that a homogenous prill product comprising schertelite (i.e., a homogenous product with slow-, intermediate-, and fast-release phosphorous in each granule) was more effective at releasing phosphorous content than a comparable co-blended fertilizer which does not comprise schertelite (i.e., a product with a slow-, and fast-release phosphorous provided in individual separate granules).

One application of a fertilizer as described herein is in growing crops that are harvested for carbohydrates such as grains, starches, sugar and the like. Examples of such crops include corn, wheat, rice, barley, oats, potatoes, sweet potatoes, sugar cane, sugar beets, or other similar plants. Another application of a fertilizer as described herein is in growing oil seeds such as canola and soybeans or other similar plants. Yet another application of a fertilizer as described herein is in growing turf or other similar plants. Such a fertilizer is preferably applied below the soil line near the root zone. The fertilizer may be placed near the seed.

### Interpretation of Terms

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof; elements which are integrally formed may be considered to be connected or coupled;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.
“and/or” is used to indicate one or both stated cases may occur, for example A and/or B includes both (A and B) and (A or B).
“approximately” when applied to a numerical value means the numerical value±10%.
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features.
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

While a number of exemplary aspects and embodiments are discussed herein, those of skill in the art will recognize certain modifications, permutations, additions and sub-combinations thereof.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

It is emphasized that the invention relates to all combinations of the above features, even if these are recited in different claims.

1-40. (canceled)

41. A fertilizer composition comprising particles of schertelite, wherein the schertelite content in the fertilizer composition is at least 10% by weight of the fertilizer composition.

42. The fertilizer composition according to claim 41, wherein the schertelite content in the fertilizer composition is in the range of about 10% to about 80% by weight.

43. The fertilizer composition according to claim 41, wherein a molar ratio of magnesium to phosphorus of the fertilizer composition is less than about 1.5.

44. The fertilizer composition according to claim 41, wherein the water soluble P₂O₅ content is about or greater than 25% by weight of the total P₂O₅ available in the fertilizer composition.

45. The fertilizer composition according to claim 41, wherein a moisture content of the fertilizer composition is less than 10% by weight.

46. The fertilizer composition according to claim 41, further comprising particles of a slow-release source of phosphorus.

47. The fertilizer composition according to claim 46, wherein the slow-release source of phosphorus comprises struvite.

48. The fertilizer composition according to claim 46, wherein the content of the slow-release source of phosphorus in the fertilizer composition is in the range of about 0% to about 40% by weight.

49. The fertilizer composition according to claim 41, further comprising particles of a fast-release source of phosphorus.

50. The fertilizer composition according to claim 49, wherein the fast-release source of phosphorus is one or more of phosphoric acid, single super phosphate (SSP), double super phosphate (DSP), triple super phosphate (TSP), monoammonium phosphate (MAP), diammonium phosphate (DAP) and dicalcium phosphate.

51. The fertilizer composition according to claim 49, wherein the content of the fast-release source of phosphorus in the fertilizer composition is in the range of from about 0% to about 65% by weight.

52. The fertilizer composition according to claim 51, further comprising one or more intermediate products, wherein the one or more intermediate products are formed from the production of one or more of schertelite, slow-release source of phosphorus and fast-release source of phosphorus.

53. The fertilizer composition according to claim 52, wherein the total content of the one or more intermediate products is less than about 20% by weight of the fertilizer composition.

54. The fertilizer composition according to claim 41, wherein the fertilizer composition further comprises one or more of dittmarite, hannayite, newberyite, mascagnite and bassanite.

55. The fertilizer composition according to claim 54, wherein a nitrogen content in the fertilizer composition is in the range from about 3% to about 20% by weight.

56. The fertilizer composition according to claim 41, wherein a magnesium content in the fertilizer composition is in the range from about 0% to about 20% by weight.

57. The fertilizer composition according to claim 41, wherein a N-P-K rating of the fertilizer composition is 8-43-0, or 5-28-0.

58. The fertilizer composition according to claim 41, further comprising particles of one or more additional minerals.

59. The fertilizer composition according to claim 56, wherein the one or more additional minerals comprise polyhalite.

60. The fertilizer composition according to claim 41, wherein the fertilizer composition is in the form of fertilizer particles.

61. The fertilizer composition according to claim 60, wherein the fertilizer particles consist essentially of schertelite.

62. The fertilizer composition according to claim 60, wherein the fertilizer particles consist essentially of schertelite and the slow-release source of phosphorus.

63. The fertilizer composition according to claim 60, wherein the fertilizer particles consist essentially of schertelite and the fast-release source of phosphorus.

64. The fertilizer composition according to claim 60, wherein the fertilizer particles consist essentially of schertelite, the slow-release source of phosphorus and the fast-release source of phosphorus.

65. The fertilizer composition according to claim 60, further comprising a layer of coating surrounding an outer layer of the fertilizer particles.

66. The fertilizer composition according to claim 60, wherein a diameter of the fertilizer particles is in the range of from about 0.2 mm to about 20 mm.

67. The fertilizer composition according to claim 60, wherein a size guide number (SGN) of the fertilizer particles is in the range of from about 250 SGN to about 350 SGN.

68. The fertilizer composition according to claim 60, wherein an uniformity index of the fertilizer particles is greater than about 45.

69. The fertilizer composition according to claim 60, wherein a crush strength of the fertilizer particles is at least about 3 lbf or 1.36 kgf.

70. The fertilizer composition according to claim 60, wherein the fertilizer particles have a level of crystallinity in the range of from about 87% to about 94%.

71. A fertilizer composition comprising:
particles of an intermediate-release source of phosphorus, wherein the solubility of the intermediate-release source of phosphorus is greater than the solubility of a slow-release source of phosphorus characterized by low water solubility and less than the solubility of a fast-release source of phosphorus characterized by high water solubility, wherein the content of the intermediate-release source of phosphorus in the fertilizer composition is greater than about 10% by weight of the fertilizer composition,
and wherein the solubility of the intermediate-release source of phosphorus is less than the solubility of phosphoric acid, single super phosphate (SSP), double super phosphate (DSP), triple super phosphate (TSP), monoammonium phosphate (MAP), or diammonium phosphate (DAP), and the solubility of the intermediate-release source of phosphorus in water is greater than 170 mg/L at 25° C.

72. A fertilizer composition comprising:
particles of an intermediate-release source of phosphorus, wherein the solubility of the intermediate-release source of phosphorus is:
(a) greater than the solubility of a slow-release source of phosphorus characterized by low water solubility, and
(b) less than the solubility of a fast-release source of phosphorus characterized by high water solubility;
wherein the content of the intermediate-release source of phosphorus in the fertilizer composition is greater than about 10% by weight of the fertilizer composition;
wherein the fast-release source of phosphorus has a solubility in water at 20° C. of at least 120 g/L; and
wherein the solubility of the intermediate-release source of phosphorus in water is greater than about 170 mg/L at 25° C.

73. The fertilizer composition according to claim 71, wherein the solubility of the intermediate-release source of phosphorus is about 15% to about 50% less than the solubility of the fast-release source of phosphorus.

74. The fertilizer composition according to claim 71, wherein the solubility of the intermediate-release source of phosphorus is about 30% to about 60% greater than the solubility of the slow-release source of phosphorus.

75. The fertilizer composition according to claim 71, wherein the intermediate-release source of phosphorus is formed by reacting a source of phosphorus with a source of magnesium.

76. The fertilizer composition according to claim 75, wherein the source of phosphorus is one or more of monoammonium phosphate (MAP), diammonium phosphate (DAP), struvite, phosphoric acid and ammonia.

77. The fertilizer composition according to claim 75, wherein source of magnesium is one or more of magnesium oxide and magnesium hydroxide.

78. The fertilizer composition according to claim 75, wherein a molar ratio of magnesium to phosphorus of the fertilizer composition is less than about 1.5.

79. A fertilizer composition comprising particles of schertelite, wherein the schertelite content in the fertilizer composition is at least 2% by weight of the fertilizer composition.

80. A fertilizer composition comprising:
particles of an intermediate-release source of phosphorus, wherein the solubility of the intermediate-release source of phosphorus is greater than the solubility of a slow-release source of phosphorus characterized by low water solubility and less than the solubility of a fast-release source of phosphorus characterized by high water solubility, wherein the solubility of the intermediate-release source of phosphorus is less than the solubility of phosphoric acid, single super phosphate (SSP), double super phosphate (DSP), triple super phosphate (TSP), monoammonium phosphate (MAP), or diammonium phosphate (DAP), and the solubility of the intermediate-release source of phosphorus in water is greater than 170 mg/L at 25° C.

81. A fertilizer composition comprising:
particles of an intermediate-release source of phosphorus, wherein the solubility of the intermediate-release source of phosphorus is greater than the solubility of a slow-release source of phosphorus characterized by low water solubility and less than the solubility of a fast-release source of phosphorus characterized by high water solubility;
wherein the fast-release source of phosphorus has a solubility in water at 20° C. of at least 120 g/L; and
wherein the solubility of the intermediate-release source of phosphorus in water is greater than 170 mg/L at 25° C.
